(19) United States
(12) Patent Application Publication
(10) Pub. No.: US 2026/0340292 A1
(43) Pub. Date: Oct. 29, 2026

(54) DETECTING BIAS BY OPTIMIZING TOKENS IN NATURAL LANGUAGE PROCESSING MODELS

(71) Applicant: INTERNATIONAL BUSINESS MACHINES CORPORATION, ARMONK, NY (US)

(72) Inventors: Khyati Patel, Jersey City, NJ (US); Raj Nagesh, NEW HILL, NC (US)

(21) Appl. No.: 19/190,304

(22) Filed: Apr. 25, 2025

(51) Int. Cl. G06F 40/30; G06F 16/93; G06F 40/242; G06F 40/284; G06F 40/40

(52) U.S. Cl. CPC G06F 40/30; G06F 16/93; G06F 40/242; G06F 40/284; G06F 40/40

(57) ABSTRACT

A word embedding model is trained on a language model, comprising a domain corpus, wherein the word embedding model is used for computing a semantic similarity between two or more pieces of texts. A dictionary including bias inducing keywords for monitoring in the language model to detect bias is received as input, wherein the dictionary further comprises bias tokens specific to a use case. In response to receiving, by the word embedding model, two or more documents for comparison, bias is detected in the language model based on the comparison of the two or more documents via use of the dictionary, and by extracting logical blocks of texts from the two or more documents being compared, and by computing semantic similarities.

### BACKGROUND

Embodiments relate to a method, system, and computer program product for detecting bias by optimizing tokens in natural language processing models.

Large language models (LLMs) are computational models designed to handle natural language processing (NLP) tasks, such as generating human-like text. LLMs learn to perform these tasks by analyzing statistical relationships within massive datasets of text during a training phase. M any LLMs are constructed using artificial neural networks based on a decoder-only transformer architecture, which is particularly effective for language-related applications. To adapt them for specific purposes, LLMs may be fine-tuned with targeted datasets or directed by using prompt engineering techniques.

However, LLMs face a notable challenge with bias. Bias refers to systematic errors or prejudices in the models' predictions, often arising from the characteristics of the training data. As awareness of these embedded biases has increased, a growing number of studies have emerged, proposing methods to measure and address social and other types of bias in LLMs.

Word embeddings may assist an Artificial Intelligence (AI) system to understand how words are used in a collection of texts by looking at the context around them. Word embeddings give each word a set of numbers, called a “word vector” based on how it relates to other words. These numbers allow the system to measure how close or similar words are to each other in meaning or use. When applied to a large group of texts, word embeddings may show connections between words. A word vector is like a point in a multi-dimensional space with which mathematical operations may be performed to process natural language. Word embeddings, while powerful for natural language processing tasks, may reflect and amplify biases present in the training data.

### SUMMARY

Provided are a method, system, and computer program product in which a word embedding model is trained on a language model, comprising a domain corpus, wherein the word embedding model is used for computing a semantic similarity between two or more pieces of texts. A dictionary including bias inducing keywords for monitoring in the language model to detect bias is received as input, wherein the dictionary further comprises bias tokens specific to a use case. In response to receiving, by the word embedding model, two or more documents for comparison, bias is detected in the language model based on the comparison of the two or more documents via use of the dictionary, and by extracting logical blocks of texts from the two or more documents being compared, and by computing semantic similarities.

In additional embodiments, computing the semantic similarity comprises computing a cosine similarity. Operations are performed to tokenize the logical blocks of texts from a first document and second document being compared, and passing the tokens through the language model. Operations are performed to compute a cosine similarity score between the logical blocks of texts from the first document and the second document using the word embedding model with keyword tokens that are in a language model vocabulary from the first document and the second document.

In yet additional embodiments, operations are performed to compute a bias error ratio term for a ratio of the bias inducing words in the first and the second document. The bias inducing keywords are maintained in the dictionary, and the dictionary is used to identify the bias inducing keywords in each logical text block being used in the domain corpus of the language model.

In further embodiments, the cosine similarity score is multiplied with a bias error ratio term to penalize an original score for a number of words that are bias inducing in the logical blocks of texts.

In yet further embodiments, an overlapping term is applied to penalize the original score further, wherein the overlapping term takes overlapping bias inducing words into consideration.

In certain embodiments, retraining of the language model to avoid bias is avoided by using the dictionary, wherein the semantic similarity is penalized based on bias inducing keywords in the dictionary.

In further embodiments, the language model is a natural processing model comprising a large language model (LL M) that has been trained on data that is prone to bias.

### BRIEF DESCRIPTION OF THE DRAWINGS

Referring now to the drawings in which like reference numbers represent corresponding parts throughout:

FIG. 1 illustrates a computing environment, in accordance with certain embodiments.

FIG. 2 illustrates a flowchart that shows first exemplary operations, in accordance with certain embodiments.

FIG. 3 illustrates a flowchart that shows score adjustment mechanisms, in accordance with certain embodiments.

FIG. 4 illustrates a block diagram that shows an example for detecting bias, in accordance with certain embodiments.

FIG. 5 illustrates a flowchart that shows second exemplary operations, in accordance with certain embodiments.

FIG. 6 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Language models, encompassing both word embedding models and large language models, are foundational to natural language processing tasks, yet they face the significant challenge of bias. Word embedding models, which are unsupervised shallow neural networks, and LLMs, trained on vast datasets such as books, search histories, and documents, depend heavily on the quality of their training corpora. When these datasets contain biased, skewed, or misinterpreted information, the resulting vector embeddings inherit these flaws, leading to model outputs that perpetuate the same biases. This can manifest into unfair or discriminatory responses, undermining the reliability and fairness of these technologies.

Current efforts to mitigate this issue typically involve fine-tuning the entire model by incorporating new words or tokens into the corpus. However, this approach has notable drawbacks. It is computationally expensive and memory-intensive, demanding substantial training data without directly addressing the underlying biases embedded in the vector representations. Moreover, there may be no established mechanism to adjust similarity metrics, such as cosine or Jaccard similarity metrics to account for bias, limiting the ability to detect or correct for bias effectively. Existing solutions also lack flexibility; they may not offer personalized mechanisms that enable users to define a custom bias dictionary tailored to specific use cases. Additionally, word embedding models may currently lack a feedback mechanism to identify and rectify biases, further constraining their adaptability.

To address these problems, certain embodiments provide a method, system, and computer program product that updates and optimizes word embeddings and their associated similarity scores. This approach facilitates bias detection and mitigation within language models. It can be applied to practical scenarios, such as measuring the similarity between text documents while accounting for specific biases (e.g., gender or racial bias). Furthermore, it enables the evaluation of large language models using a user-defined bias dictionary, offering a customizable and efficient solution that aligns with diverse business needs. By overcoming the limitations of traditional methods, such embodiments provide improved mechanisms for fairer and more adaptable language technologies in a computational device and improve the operations performed by the computational device.

Certain embodiments provide mechanisms to optimize the word vector embeddings and similarity score computed using the embeddings from a language model's vector space, thereby enabling bias detection and alignment in language models. A cost function is defined to optimize the similarity score from words that induce bias in the training corpus and based on the penalizing factor it helps detect bias in the model.

Previous solutions may have taken several hours to days depending on the dataset and n-gram level to retrain an embedding model or fine tune an LL M. Such solutions may have been expensive and resource intensive to retrain or fine tune a language model. Additionally such mechanisms may not have penalized the cosine similarity based on bias inducing keywords in the training corpus. Furthermore, there may not have been a feedback mechanism in word embedding models, in earlier provided solutions.

In an exemplary scenario, a human resource professional needs to compare their Candidate Resume text to a Job Description Text to check how similar they are but also needs to make sure there is no bias while performing comparisons using vector embeddings from Language Models and Embedding Models. In certain embodiments, the user may use the optimized word embedding to view the semantic comparability as well as the underlying embeddings that are different. They can quickly formulate their argument or adjust their strategy for further document processing.

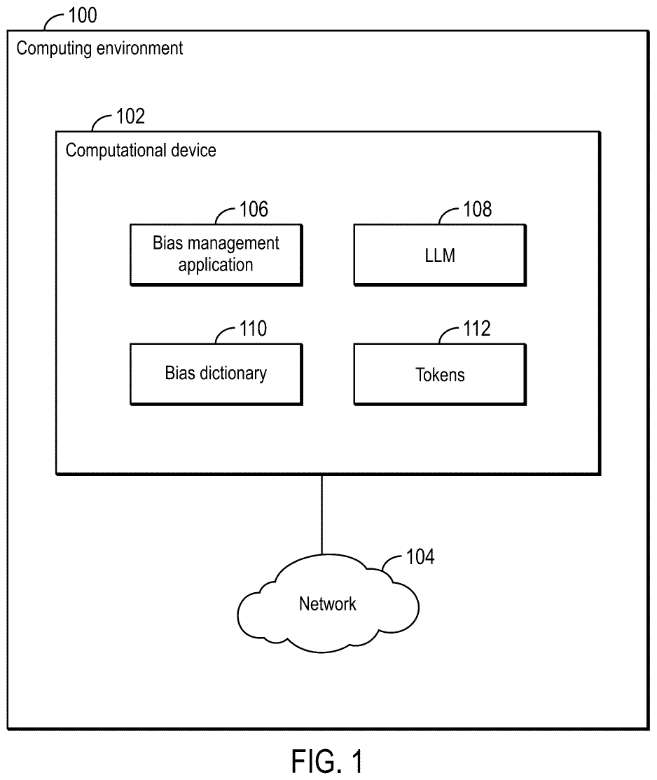

FIG. 1 illustrates a computing environment 100, in accordance with certain embodiments. At least one computational device 102 is coupled to a network 104 in the computing environment 100.

The computational device 102 executes a bias management application 106 that uses an LLM 108 and a bias dictionary 110 in association with tokens 112 that are generated from documents. In certain embodiments, the bias management application 106 and the LLM 108 may be implemented in hardware, firmware, software, or any combination thereof.

The computational device 102 may comprise any suitable computational device known in the art such as a server, a personal computer, a laptop, a mainframe, etc. The network 104 may comprise any suitable network known in the art such as the Internet, a local area network, a wide area network, etc. Adapters, routers, switches, etc., may couple the computational device 102 to the network 104.

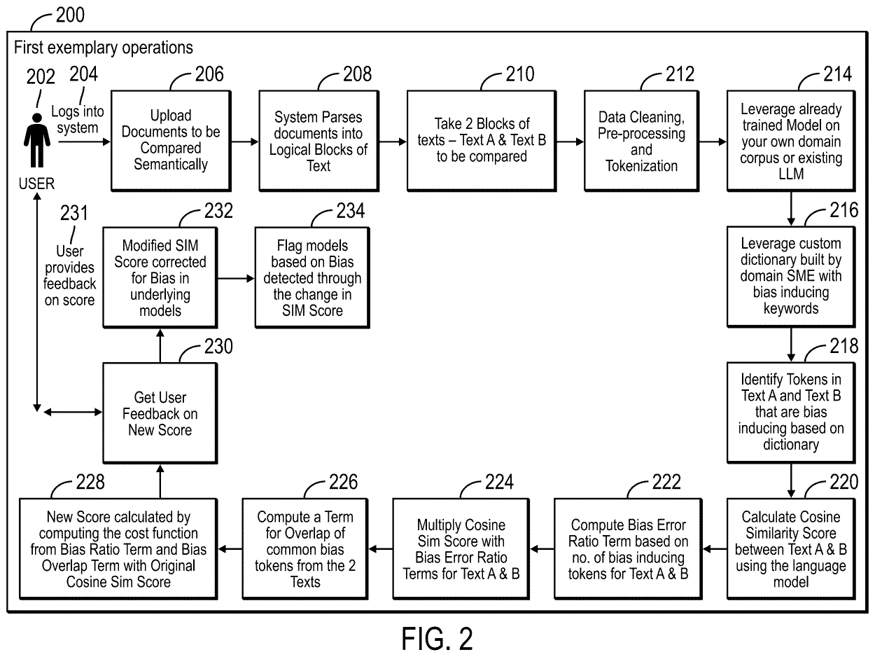

FIG. 2 illustrates a flowchart 200 that shows first exemplary operations, in accordance with certain embodiments. In certain embodiments, the operations shown in the flowchart 200 may be performed in the computational device 102.

A user 202 logs on to a system (reference numeral 204) and uploads (at block 206) documents that are to be compared semantically. Control proceeds to block 208, where the system parses the documents into logical blocks of text. The bias management application 106 that executes in the system, takes two blocks of texts, referred to as Text A and Text B that are to be compared (at block 210). From block 210 control proceeds to block 212 in which data cleaning, pre-processing and tokenization are performed.

Control then proceeds to block 214 in which the bias management application 106 leverages already trained model on an own domain corpus or on an existing LLM.

The process then leverages (at block 216) a custom dictionary (bias dictionary 110 as shown in FIG. 1) that has been built by a domain subject matter expert (SM E) with bias inducing keywords. The process identifies (at block 218) tokens (e.g., tokens 112 as shown in FIG. 1) in Text A and Text B that are bias inducing based on the dictionary.

From block 218 control proceeds to block 220 in which the bias management application 106 calculates a cosine similarity score between Text A and Text B using the language model, and then computes (at block 222) a Bias Error Ratio Term based on the number of bias inducing tokens for Text A and Text B. The bias management application 106, multiplies (at block 224) a Cosine Similarity (Similarity is abbreviated as Sim or SIM) Score with Bias Error Ratio Terms for Text A and Text B, Subsequently, the bias management application 106 computes (at block 226) a term for overlap of common bias tokens from the two texts, and the bias management application 106 calculates (at block 228) a new score by computing the cost function from Bias Ratio Term and Bias Overlap Term with the original cosine sim score.

The bias management application 106 then gets (at block 230) user feedback on the new score (as shown via reference numeral 231). The modified SIM Score is corrected (at block 232) for bias in underlying models by the bias management application 106. The bias management application 106 then flags (at block 234) models based on bias detected through the change in SIM score.

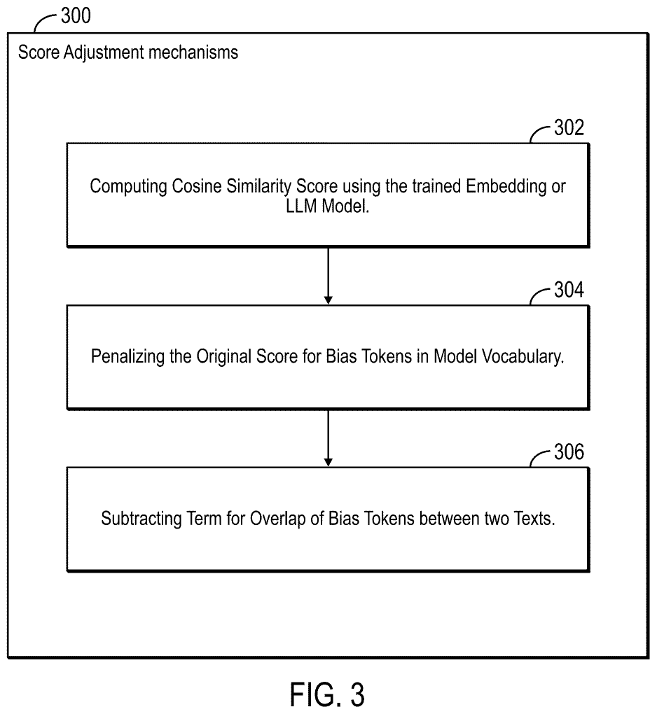

FIG. 3 illustrates a flowchart 200 that shows score adjustment mechanisms, in accordance with certain embodiments. In certain embodiments, the operations shown in the flowchart 300 may be performed in the computational device 102.

Control starts at block 302 in which the bias management application 106 computes the Cosine Similarity Score using a trained Embedding or an LLM Model. This is performed by first training a custom Word Embedding model on a domain corpus or a Small Language Model or on an existing Large Language Model. This model may be used for computing the semantic similarity (e.g., cosine similarity) between two pieces of texts. The process can use any similarity computing algorithm for the base semantic similarity score.

Then to perform the logic of block 302, users may login to the system and upload the documents or input texts which need to be compared. This comparison exercise may enable detecting bias in the underlying model and help mitigate the effects of the bias. The documents are parsed, and logical blocks of texts are extracted from each of them where documents need to be compared.

To perform the logic of block 302, the system also takes an input in the form of a custom-built SM E owned dictionary which comprises of bias inducing keywords that need to be monitored in the underlying model to detect bias. This custom dictionary contains all bias tokens specific to the use case where the system is being applied to.

Additionally, the two blocks of texts to be compared Text A and Text B are tokenized using a natural language toolkit (NLTK) and the tokens are passed through the Language model to identify:
(a.) the tokens/keywords that are bias inducing (matches tokens in Dictionary) in Text A
(b) the tokens/keywords that are bias inducing (matches tokens in Dictionary) in Text B

The process computes cosine similarity score between the two blocks of texts-Text A and Text B using the model with keyword tokens that are in the model vocabulary from both the texts. The Cosine Similarity Score is output as S_org in the logic shown in block 302.

From block 302 control proceeds to block 304 in which the original score is penalized for bias tokens in the model vocabulary. Such operations are performed in three phases.

In a first phase the process computes an error ratio term for the ratio of bias inducing words in each text (number is abbreviated as “no”, in the equations below):

Bias_A=[1−(no. of Bias inducing tokens in Text A/total no. of tokens in Text A)]. (a)

Bias_B=[1−(no. of Bias inducing tokens in Text B/total no. of tokens in Text B)]. (b)

In a second phase, the Bias Inducing Keywords are maintained in the Custom-Built Dictionary and owned and managed by an SM E for the specific use case domain this system is being implemented in. Embodiments may use this dictionary to identify the bias inducing keywords in each of the text blocks that eventually may be used in the underlying corpus of the language model as well.

In a third phase, the process multiplies the cosine similarity score S_org computed in block 302 with the Bias error ratio terms Bias_A and Bias_B. This penalizes the original score for the number of words that are Bias inducing in the two blocks of texts. and this product is referred to as S_New, where:

S_New=S_org×Bias_A×Bias_B

Control then proceeds to block 306 in which operations are performed to subtract term for overlap of bias tokens between two texts, by performing the following operations.

Although embodiments took into consideration the Bias tokens across the two texts for penalizing the similarity score, the embodiments have not yet penalized for the overlapping Bias inducing words that are common across the two text blocks A and B.

The double Bias could be an issue in human resource use case described earlier where both candidate and job have bias texts, and the system needs to detect that and penalize again for it. Certain embodiments use another term (“Overlap_term”) to penalize the score a bit further by taking into consideration the overlapped Bias inducing words, where:

Overlap_term=count (intersection of Bias tokens from Text A and Text B)/Square Root [no. (Bias_A)×no. (Bias_B)],

and this may also be expressed as:

$$Overlap\_term = \frac{len ( Bias\_A ⋂ Bias\_B )}{\sqrt{len ( Bias\_A ) X len ( Bias\_B )}}$$

Other embodiments may compute the “Overlap_term” that is used to penalize the score via different equations.

Certain embodiments use a constant “a”, which is between 0 and 1 with the term that further penalizes the score “S_New” that was calculated earlier for the overlapped Bias words between both the texts. Note that if there is no overlap between the two sets of Bias inducing words, the new score would remain S_New that was calculated before. In certain embodiments the following calculations are made:

Bias_Penalized_Score=S_New−[a(1−S_New)]×Overlap_term

The Bias_Penalized_Score Equation with the full notation of Cost Function after combining expressions from earlier operations is provided below::

$$Bias\_Penalized \_Score = Cosine\_Sim ( A , B ) X Bias\_A X Bias\_B - [ a ( 1 - Cosine\_Sim ( A , B ) X Bias\_A X Bias\_B ) ] X \{ \frac{len ( {Bias}_{A} ⋂ {Bias}_{B} )}{\sqrt{len ( {Bias}_{A} ) X l en ( {Bias}_{B} )}} \}$$

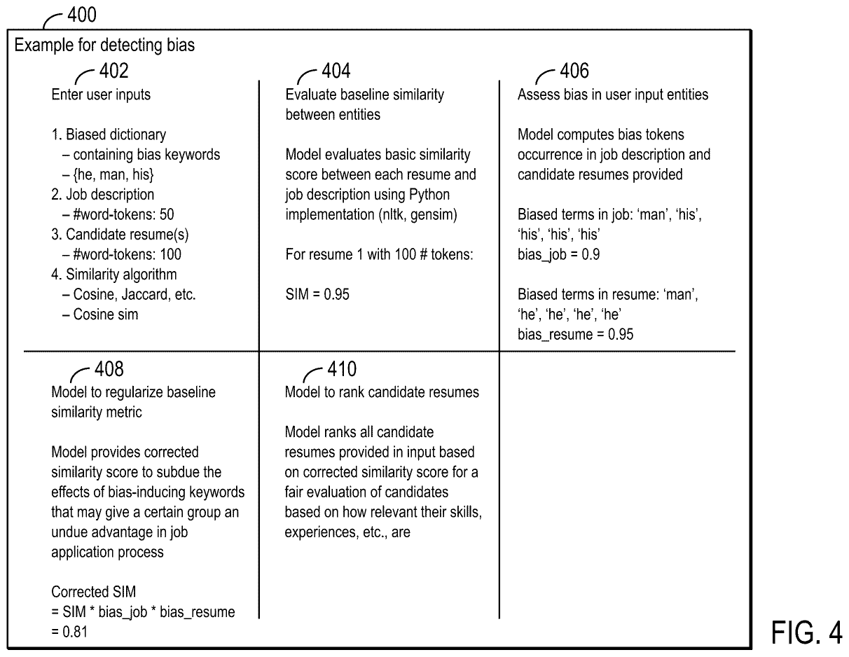

FIG. 4 illustrates a block diagram 400 that shows an example for detecting bias, in accordance with certain embodiments. FIG. 4 shows a use case walkthrough with an example. The example walkthrough shows how a gender bias detector and aligner model for human resource work for candidate resume and job description.

User inputs are entered (as shown via reference numeral 402). This includes a bias dictionary containing bias keywords such as “he, man, his”. The number of word-token in the job description and candidate resumes are calculated. The similarity algorithms to be used such as Cosine, Jaccard, etc. are mentioned and cosine similarity measures are provided.

The process then evaluates (reference numeral 404) the baseline similarity between entities. The model evaluates basic similarity score between each resume and job description using Python implementation (nltk, gensim). In one example, For resume 1 with 100 tokens: SIM=0.95

The process then assesses bias (reference numeral 406) in user input entities. The model computes bias tokens occurrence in job description and candidate resumes provided. Biased terms in job may include ‘man’, ‘his’, ‘his’, ‘his’, ‘his’. The bias_job=0.9 and the Biased terms in resume: ‘man’, ‘he’, ‘he’, ‘he’, ‘he’ and the bias_resume=0.95 are shown.

Control proceeds to block 408 that shows a model to regularize baseline similarity metric. The model provides corrected similarity scores to subdue the effects of bias-inducing keywords that may give a certain group an undue advantage in the job application process. In such embodiments,

Corrected SIM=SIM×bias_job×bias_resume-overlap_term=0.81

Then control process to perform operations (shown via reference numeral 410) that shows a model to rank candidate resumes. The model ranks all candidate resumes provided in input based on corrected similarity score for a fair evaluation of candidates based on how relevant their skills, experiences, etc.

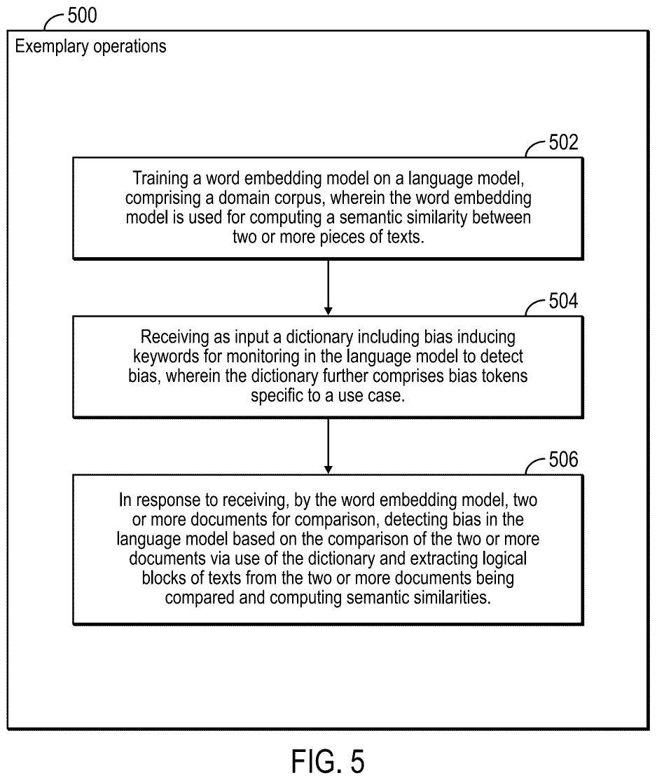

FIG. 5 illustrates a flowchart 500 that shows second exemplary operations, in accordance with certain embodiments.

Control starts at block 502 in which a word embedding model is trained on a language model, comprising a domain corpus, wherein the word embedding model is used for computing a semantic similarity between two or more pieces of texts.

From block 502 control proceeds to block 504 in which a dictionary including bias inducing keywords for monitoring in the language model to detect bias is received as input wherein the dictionary further comprises bias tokens specific to a use case. In response to receiving, by the word embedding model, two or more documents for comparison, bias is detected (at block 506) in the language model based on the comparison of the two or more documents via use of the dictionary, and by extracting logical blocks of texts from the two or more documents being compared and by computing semantic similarities.

The embodiments described in FIGS. 1-5 may be employed in a variety of scenarios, and a few additional exemplary scenarios are described below.

In an exemplary scenario, a data scientist works on a project and has built a word embedding or small language model by training on a known corpus of data. While using the solution for underlying applications the team realizes there is bias in computing similarity scores leveraging the trained vector embeddings due to some bias induced in the training corpus. Instead of spending significant amount of time retraining the model, the data scientist may use the embodiments to account for the bias in the corpus and optimize the similarity scoring method to mitigate the bias impact.

In another exemplary scenario, an AI workflow (or a chatbot) in a business domain leverages an LLM that has been trained on public internet data that may be prone to gender bias. The model has erroneously learned that certain gender groups are better suited for certain roles in the society. When users interact with the chatbot, the responses favor these gender groups further contributing to discrimination in the gender dynamics. A bias detector model/equation as described in the embodiments may quantify the bias in the LLM, and warn the user so they can potentially remedy the responses.

The bias detection and quantification model described in the embodiments may be added as an add-on feature to many applications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRA M), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

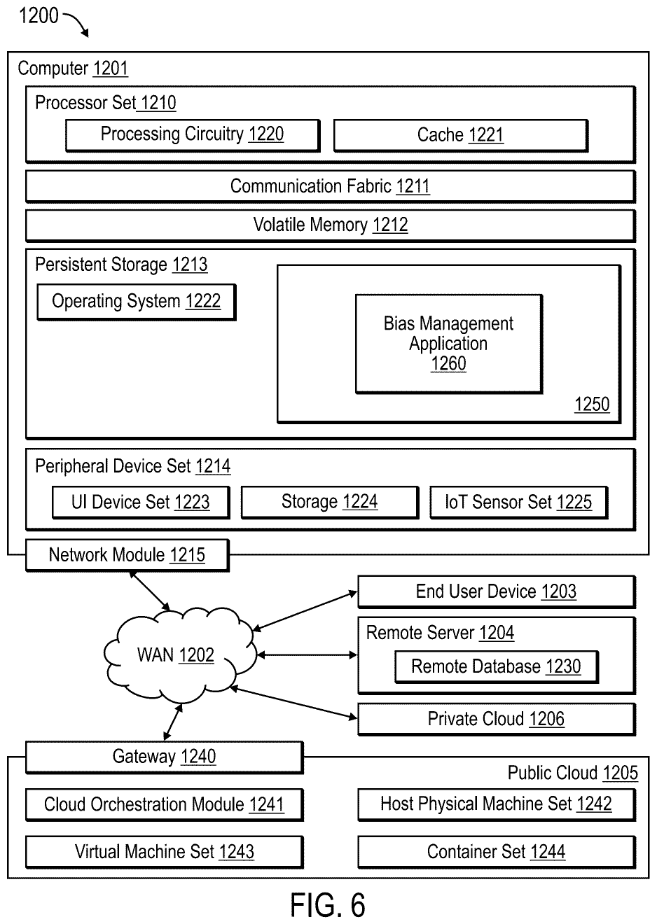

In FIG. 6, a computing environment 1200 contains an example of an environment for the execution of at least some of the computer code (block 1250) involved in performing the operations for a bias management application 1260 that performs operations shown in FIGS. 1-5.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IOT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RA M. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LA Ns) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (V CEs) typically take the form of virtual machines from virtual machine set 1243 and/or containers from container set 1244. It is understood that these V CEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. M any modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
training a word embedding model on a language model, comprising a domain corpus, wherein the word embedding model is used for computing a semantic similarity between two or more pieces of texts;
receiving as input a dictionary including bias inducing keywords for monitoring in the language model to detect bias, wherein the dictionary further comprises bias tokens specific to a use case; and
in response to receiving, by the word embedding model, two or more documents for comparison, detecting bias in the language model based on the comparison of the two or more documents via use of the dictionary and extracting logical blocks of texts from the two or more documents being compared and computing semantic similarities.

2. The method of claim 1, wherein computing the semantic similarity comprises comprise computing a cosine similarity, the method further comprising:
tokenizing the logical blocks of texts from a first document and second document being compared, and passing the tokens through the language model; and
computing a cosine similarity score between the logical blocks of texts from the first document and the second document using the word embedding model with keyword tokens that are in a language model vocabulary from the first document and the second document.

3. The method of claim 2, the method further comprising:
computing a bias error ratio term for a ratio of the bias inducing words in the first and the second document; and
maintaining the bias inducing keywords in the dictionary, and using the dictionary to identify the bias inducing keywords in each logical text block being used in the domain corpus of the language model.

4. The method of claim 2, the method further comprising:
multiplying the cosine similarity score with a bias error ratio term to penalize an original score for a number of words that are bias inducing in the logical blocks of texts.

5. The method of claim 4, the method further comprising:
applying an overlapping term to penalize the original score further, wherein the overlapping term takes overlapping bias inducing words into consideration.

6. The method of claim 1, wherein retraining of the language model to avoid bias is avoided by using the dictionary, and wherein the semantic similarity is penalized based on bias inducing keywords in the dictionary.

7. The method of claim 1, wherein the language model is a natural processing model comprising a large language model (LLM) that has been trained on data that is prone to bias.

8. A system, comprising:
a memory; and
a processor coupled to the memory, wherein the processor performs operations, the operations comprising:
training a word embedding model on a language model, comprising a domain corpus, wherein the word embedding model is used for computing a semantic similarity between two or more pieces of texts;
receiving as input a dictionary including bias inducing keywords for monitoring in the language model to detect bias, wherein the dictionary further comprises bias tokens specific to a use case; and
in response to receiving, by the word embedding model, two or more documents for comparison, detecting bias in the language model based on the comparison of the two or more documents via use of the dictionary and extracting logical blocks of texts from the two or more documents being compared and computing semantic similarities.

9. The system of claim 8, wherein computing the semantic similarity comprises comprise computing a cosine similarity, the operations further comprising:
tokenizing the logical blocks of texts from a first document and second document being compared, and passing the tokens through the language model; and
computing a cosine similarity score between the logical blocks of texts from the first document and the second document using the word embedding model with keyword tokens that are in a language model vocabulary from the first document and the second document.

10. The system of claim 9, the operations further comprising:
computing a bias error ratio term for a ratio of the bias inducing words in the first and the second document; and
maintaining the bias inducing keywords in the dictionary, and using the dictionary to identify the bias inducing keywords in each logical text block being used in the domain corpus of the language model.

11. The system of claim 9, the operations further comprising:
multiplying the cosine similarity score with a bias error ratio term to penalize an original score for a number of words that are bias inducing in the logical blocks of texts.

12. The system of claim 11, the operations further comprising:
applying an overlapping term to penalize the original score further, wherein the overlapping term takes overlapping bias inducing words into consideration.

13. The system of claim 8, wherein retraining of the language model to avoid bias is avoided by using the dictionary, and wherein the semantic similarity is penalized based on bias inducing keywords in the dictionary.

14. The system of claim 8, wherein the language model is a natural processing model comprising a large language model (LLM) that has been trained on data that is prone to bias.

15. A computer program product comprising a computer readable storage medium having computer readable program code embodied therewith, wherein the computer readable program when executed by a processor performs operations, the operations comprising:
training a word embedding model on a language model, comprising a domain corpus, wherein the word embedding model is used for computing a semantic similarity between two or more pieces of texts;
receiving as input a dictionary including bias inducing keywords for monitoring in the language model to detect bias, wherein the dictionary further comprises bias tokens specific to a use case; and
in response to receiving, by the word embedding model, two or more documents for comparison, detecting bias in the language model based on the comparison of the two or more documents via use of the dictionary and extracting logical blocks of texts from the two or more documents being compared and computing semantic similarities.

16. The computer program product of claim 15, wherein computing the semantic similarity comprises comprise computing a cosine similarity, the operations further comprising:
tokenizing the logical blocks of texts from a first document and second document being compared, and passing the tokens through the language model; and
computing a cosine similarity score between the logical blocks of texts from the first document and the second document using the word embedding model with keyword tokens that are in a language model vocabulary from the first document and the second document.

17. The computer program product of claim 16, the operations further comprising:
computing a bias error ratio term for a ratio of the bias inducing words in the first and the second document; and
maintaining the bias inducing keywords in the dictionary, and using the dictionary to identify the bias inducing keywords in each logical text block being used in the domain corpus of the language model.

18. The computer program product of claim 16, the operations further comprising:
multiplying the cosine similarity score with a bias error ratio term to penalize an original score for a number of words that are bias inducing in the logical blocks of texts.

19. The computer program product of claim 18, the operations further comprising:
applying an overlapping term to penalize the original score further, wherein the overlapping term takes overlapping bias inducing words into consideration.

20. The computer program product of claim 15, wherein retraining of the language model to avoid bias is avoided by using the dictionary, and wherein the semantic similarity is penalized based on bias inducing keywords in the dictionary.
